(19) United States
(12) Patent Application Publication
(10) Pub. No.: US 2021/0221176 A1
(43) Pub. Date: Jul. 22, 2021

(54) PNEUMATIC VEHICLE TIRE

(71) Applicant: Continental Reifen Deutschland GmbH, Hannover (DE)

(72) Inventors: Ana Iordanou, Hannover (DE); Emine Dilhun Oersler, Hannover (DE); Andre Lutz, Hannover (DE); Frantisek Cebik, Belusa (SK)

(21) Appl. No.: 16/095,889

(22) PCT Filed: Feb. 13, 2017
(86) PCT No.: PCT/EP2017/053092

§ 371 Date: Oct. 23, 2018

(30) Foreign Application Priority Data
Apr. 25, 2016 (DE) 10 2016 206 974.8

(51) Int. Cl. B60C 11/00; B29D 30/54

(52) U.S. Cl. CPC B60C 11/005; B60C 2011/0033; B29D 30/54

(57) ABSTRACT

A pneumatic vehicle tire at least having: a tread including an outer tread cap with a profiled tread and an inner tread base, a carcass, a bead region with a bead core, an inner layer and sidewalls is provided. The material thickness (d(2)) of the tread base is configured to decrease from the center of the tread toward each of the side walls. Furthermore, a method for retreading a pneumatic vehicle tire is provided.

### CROSS REFERENCE TO RELATED APPLICATIONS

This application is the national stage of PCT/EP2017/053092, filed Feb. 13, 2017, designating the United States and claiming priority from German patent application no. 10 2016 206 974.8, filed Apr. 25, 2016, the entire contents of which are incorporated herein by reference.

### BACKGROUND OF THE INVENTION

Pneumatic vehicle tires of the type in question are sufficiently well known from the prior art. These include pneumatic vehicle tires on which the underside of the tread is curved. Also known in principle are methods for retreading a pneumatic vehicle tire.

During a life cycle of a pneumatic vehicle tire, the greatest risk of damage is in the middle of the tread, for example due to the penetration of sharp objects. Normally, abrasion of the rubber of the tread is also greatest in the middle.

There is also the problem of heat developing when the pneumatic vehicle tires are being used on a driven vehicle. Most of the heat occurs in the region of the sidewalls at the shoulders of the pneumatic vehicle tire, since these regions are deformed the whole time, and to the greatest extent, during rolling, when driving around bends, etc. Consequently, dissipation of heat is necessary especially in the shoulder region. Lack of dissipation of heat, and consequently excessive development of heat in the pneumatic vehicle tire, can lead for example to the carcass being damaged.

The form of the tread is dictated by its properties and use. When retreading pneumatic vehicle tires, the old tread is roughened or peeled away by machine, a new tread is applied and then vulcanized. Here there is the risk of too much tread being removed, with the result that the underlying carcass is damaged.

### SUMMARY OF THE INVENTION

It is an object of the invention to provide an improved pneumatic vehicle tire.

The object can, for example, be achieved via a pneumatic vehicle tire at least having: a tread comprising an outer tread cap with a profiled tread and an inner tread base, a carcass, a bead region with a bead core, an inner layer and sidewalls, has been improved by the material thickness of the tread base decreasing from the center of the tread toward each of the sidewalls. In other words, the disclosure discloses a pneumatic vehicle tire in which the material thickness of the tread base is greater in a middle region than in an outer region oriented toward the sidewalls. The tread base consequently has in a section transverse to the running direction of the pneumatic vehicle tire an upwardly and outwardly arched form. This can be achieved by the tread base being made thicker in the middle or becoming thinner on the outside.

In the case of a pneumatic vehicle tire according to embodiments of the invention, the tread is better protected from damage during driving, for example when running over a nail, in the middle by the increased material thickness, that is, by the additional rubber. Consequently, the durability and lifetime of such a pneumatic vehicle tire are increased.

Furthermore, the fact that the trend base only has an increased material thickness in the middle avoids a reduction in the dissipation of heat in the shoulder regions being brought about by the additional insulating effect of a thicker rubber layer. That is, that the dissipation of heat in the shoulder regions is not adversely influenced. The pneumatic vehicle tire is protected from heat damage resulting from inadequate dissipation of heat.

An advantageous configuration provides that the tread cap has a constant profile depth over the entire tread. This can likewise increase the lifetime of the pneumatic vehicle tire, since the greatest abrasion of rubber conventionally takes place in the middle.

A possible configuration provides that the inner layer has a constant material thickness. The effect of the airtight inner layer is consequently ensured in all regions of the pneumatic vehicle tire. Alternatively, however, a configuration of the inner layer with a variable material thickness is also within the scope of the invention.

Altogether, the pneumatic vehicle tire according to the invention offers the advantage that the lifetime of the pneumatic vehicle tire is increased, in that on the one hand the pneumatic vehicle tire is protected from damage in the region of the tread and on the other hand the carcass is protected from heat damage.

The disclosure also relates to a method for retreading a pneumatic vehicle tire, a pneumatic vehicle tire as described above being used according to the disclosure. Advantageously, via the pneumatic vehicle tire according to the disclosure, when the tread that is thickened in the middle is roughened, the carcass lying thereunder can be protected better. In other words, the probability of the carcass being inadvertently removed during the roughening is reduced.

The invention will be discussed in more detail below with reference to the appended drawings. Here, the embodiment shown does not represent a restriction to the illustrated variant, but rather serves merely for the explanation of a principle of the invention.

Identical or similar components are always denoted by the same reference designations. To be able to illustrate the function according to aspects of the invention, the figures show highly simplified diagrammatic illustrations, in which components not essential to the invention have been omitted. However, this does not mean that such components are not present in a solution according to the invention.

### BRIEF DESCRIPTION OF THE DRAWINGS

The invention will now be described with reference to the drawings wherein:

FIG. 1 shows a detail of a section transverse to the running direction through a pneumatic vehicle tire known from the prior art in the region of the tread;

FIG. 2 shows a detail of a section transverse to the running direction through a pneumatic vehicle tire according to an embodiment of the invention in the region of the tread in a first configuration; and,

FIG. 3 shows a detail of a section transverse to the running direction through a pneumatic vehicle tire according to an embodiment of the invention in the region of the tread in a further configuration.

### DESCRIPTION OF THE PREFERRED EMBODIMENTS OF THE INVENTION

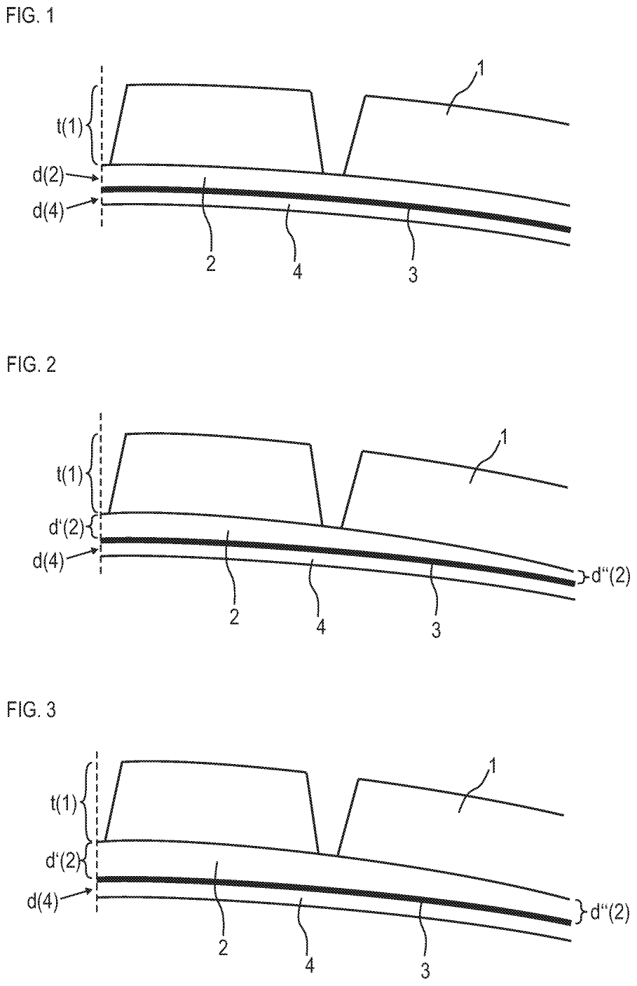

FIGS. 1 to 3 show in each case a detail of a section transverse to the running direction through a pneumatic vehicle tire in the region of the tread. In the details of the pneumatic vehicle tire that are shown here, the tread is shown with an outer tread cap 1, which forms the profiled tread, and an inner tread base 2, and also the carcass 3 lying thereunder. The profile of the tread cap 1 has the depth t(1). Arranged underneath the carcass 3, there is also the airtight inner layer 4. The inner layer 4 has the material thickness d(4). Although not shown here in detail, the carcass 3 includes a number of fabric layers embedded in rubber and a breaker belt, for example of steel, for strengthening the fabric and the rubber.

According to the prior art, see FIG. 1, the material thickness d(2) of the tread base 2 is formed with a constant thickness over the entire tread, or from the inside to the outside.

The pneumatic vehicle tires according to the invention differ from the prior art in that the material thickness d′(2) or d″(2) of the tread base 2 decreases from the center of the tread, indicated here by the dashed line, toward each of the sidewalls. This can be realized by two different configurations of the tread base 2.

The first configuration is shown in FIG. 2. Here, the material thickness d″(2) in the side regions is reduced in comparison with the material thickness d′(2) in the middle. The material thickness d′(2) in the middle consequently corresponds to the original material thickness d(2) according to FIG. 1.

The other configuration is shown in FIG. 3. Here, the material thickness d′(2) in the middle is increased in comparison with the material thickness d″(2) in the side regions. The material thickness d″(2) in the side regions consequently corresponds to the original material thickness d(2) according to FIG. 1.

In the case of both configurations, the upper side of the tread base 4 has a form that is arched more in comparison with the underside, while the underside of the tread is almost straight. Furthermore, the material thickness d(4) of the inner layer 4 is formed as constant.

It is understood that the foregoing description is that of the preferred embodiments of the invention and that various changes and modifications may be made thereto without departing from the spirit and scope of the invention as defined in the appended claims.

### REFERENCE NUMERALS

1 Tread cap
2 Tread base
3 Carcass
4 Inner layer
d (2), d′(2), d″(2) Material thickness of the tread base
d (4) Material thickness of the inner layer
t (1) Profile depth of the tread cap

1-3 (canceled)

4. A pneumatic vehicle tire comprising:
a tread having an outer tread cap with a profiled tread and an inner tread base;
a carcass;
a bead region having a bead core;
an inner layer;
said tread defining a tread center;
two sidewalls; and,
said inner tread base having a material thickness d(2), wherein said material thickness d(2) decreases from said tread center toward each of said two sidewalls.

5. The pneumatic vehicle tire of claim 4, wherein said outer tread cap has a constant profile depth over the entirety of said tread.

6. A method for retreading a tire having a carcass, an inner bead region with a bead core, an inner layer and two sidewalls, the method comprising the step of:
retreading a pneumatic vehicle tire with a tread having an outer tread cap with a profiled tread and an inner tread base, wherein the inner tread base has a material thickness d(2) and the material thickness d(2) decreases from a tread center toward each of the two sidewalls of the tire.
